(19) United States
(12) Patent Application Publication
(10) Pub. No.: US 2008/0180732 A1
(43) Pub. Date: Jul. 31, 2008

(54) Computer readable recording medium stored with control program for controlling image forming apparatus, method of controlling image forming apparatus, and image forming controller

(75) Inventors: Tamotsu Sakuraba, Saganihara-shi (JP); Toshimi Shinchi, Saitama-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/879,496

(22) Filed: Jul. 18, 2007

(30) Foreign Application Priority Data
Jan. 29, 2007 (JP) 2007-018301

(51) Int. Cl. G06F 3/12

(52) U.S. Cl. 358/1.15

(57) ABSTRACT

The present invention provides to a user a chapter break printing function setting part that allows the user to designate the leading page at a break of a document in order to set up the chapter break printing function for printing the leading page of a break of “chapter,” “section,” and the like of the document during double-side printing, as well as an insertion setting part that allows the user to designate the tab sheet insertion at the page designated by the chapter break printing function setting part.

### CROSS-REFERENCE TO RELATED APPLICATION

This application is based on Japanese Patent Application No. 2007-018301, filed on Jan. 29, 2007, the contents of which are incorporated herein by reference.

### BACKGROUND

1. Technical Field

The present invention relates to a computer readable recording medium stored with a control program for controlling an image forming apparatus having a function to insert insertion sheets into a printed material, a method of controlling an image forming apparatus, and an image forming controller.

2. Description of Related Art

There exist image forming apparatus such as copying machines and printers that are capable of creating printed products by inserting between pages a tab sheet having a flat rectangular main body and a tab protruding at a designated position on a side of said main body. See Unexamined Japanese Patent Publication No. 2005-182757. In this technology, the user can designate a page where a tab sheet is to be inserted.

In the meanwhile, there is a technology for setting up a chapter break printing function for printing a leading page of a “chapter” in a document on the front side when double-side printing is in effect. With such a technology, the user can make use of the chapter break printing function by designating the leading page of a “chapter” in a document.

In the technology disclosed by the cited patent document 1, however, the insertion sheet such as a tab sheet can be inserted only at a page designated by the user and the chapter break printing function during double-side printing is not considered.

Therefore, in order to introduce the setting for the chapter break printing function to the technology disclosed by the abovementioned patent document, it is necessary for the user to designate the leading page of a “chapter” in order to set up the chapter break printing function during double-side printing in addition to designating a page where an insertion sheet, such as a tab sheet, is to be inserted. In other words, while insertion sheets such as tab sheets are often inserted at breakpoints of a document such as chapter breaks, it makes it necessary to designate not only the insertion pages for the insertions sheets such as tab sheets, but also the leading page of each “chapter” separately and accurately. This creates not only a problem of poor productivity but also a problem of unexpected printed matters as a result of setting errors.

### SUMMARY

To solve at least one of the abovementioned problems, there is provided a computer readable recording medium stored with a control program for controlling an image forming apparatus, which reflects one aspect of the present invention. The control program causes a computer to execute a process which comprises: 1) providing to a user a chapter break printing function setting part that allows the user to designate a leading page of a break in a document in order to set up a chapter break printing function for printing the leading page on the front surface at the break of the document while double-side printing as well as an insertion setting part that allows the user to designate an insertion of an insertion sheet to a page designated at said chapter break printing function setting part; and 2) receiving the designation of the page at said printing function setting part and the designation of the insertion of the insertion sheet at said insertion setting part.

It is preferable that said insertion sheet is a tab sheet.

It is preferable that said insertion sheet is the one the user selects from a plurality of types of insertion sheets.

It is preferable that said chapter break printing function setting part has a first chapter break printing function setting part that allows the user to designate a leading page of a first break of said document in order to set up a first chapter break printing function for printing the leading page of a first break in a given document on the front side during double-side printing; and a second chapter break printing function setting part that allows the user to designate a leading page of a second break, which is finer than the first break, of said document in order to set up a second chapter break printing function for printing the leading page of a second break in the document on the front side during double-side printing; wherein said insertion setting part has a first insertion setting part that allows the user to designate insertion of an insertion sheet to the page designated at said first chapter break printing function setting part and a second insertion setting part that allows the user to designate insertion of an insertion sheet to the page designated at said second chapter break printing function setting part.

It is preferable that said first break is a chapter, and said second break is a section.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall constitution of a network system according to an embodiment of the present invention.

FIG. 2 is a block diagram showing the constitution of the PC shown in FIG. 1.

FIG. 3 is a block diagram showing the constitution of the printer controller of the printing system shown in FIG. 1.

FIG. 4 is a block diagram showing the constitution of the printer of the printing system shown in FIG. 1.

FIG. 5 is a diagram showing the typical constitution of a printing unit.

FIG. 6 is a diagram showing tab sheets used in this embodiment.

FIG. 7 is a flow chart showing the process procedure on the PC.

FIG. 8 is a diagram showing an example setting screen.

FIG. 9 is a diagram showing an example setting screen.

FIG. 10 is a flowchart showing the process sequence on the printer controller.

FIG. 11 is a flowchart showing the sequence of the preparation process for the printing data.

FIG. 12 is a flowchart showing the process sequence on the printer.

### DETAILED DESCRIPTION

The embodiment of this invention will be described below with reference to the accompanying drawings.

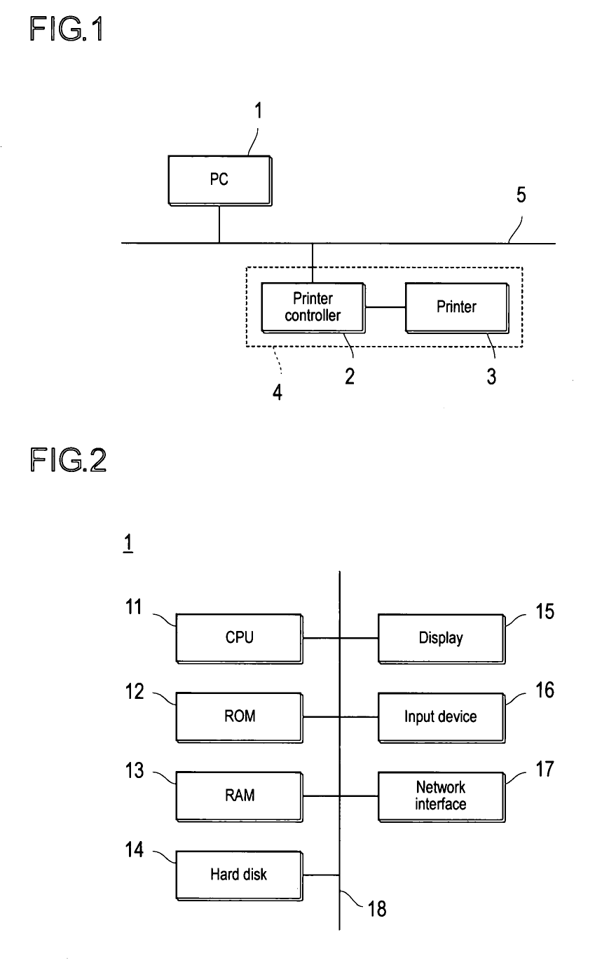

FIG. 1 is a block diagram showing the overall constitution of a network system according to an embodiment of the present invention.

The network system that relates to this embodiment is equipped with a PC 1 as a printing instruction device for instructing the printing of the document and a printing system 4 for conducting printing based on printing instructions of the PC 1, which are connected with each other via a network 5. Also, the PC 1 and the printing system 4 can be connected directly (local connection) without recourse to the network 5.

The printing system 4 consists of a printer controller 2 and a printer 3 as an image forming apparatus and also as a tab sheet insertion apparatus, which are locally connected with each other. This local connection can be accomplished by means of various local connection interfaces, such as serial interfaces, e.g., USB and IEEE 1394, parallel interfaces, e.g., SCSI and IEEE 1284, wireless communication interfaces, e.g., Bluetooth®, IEEE 802.11, HomeRF®, IrDA®, etc. However, the printer controller 2 and the printer 3 can be connected via the network 5.

FIG. 2 is a block diagram showing the constitution of PC 1 shown in FIG. 1.

The PC 1 contains a CPU 11, a ROM 12, a RAM 13, a hard disk 14, a display 15, an input device 16 and a network interface 17, all of which are interconnected via a bus 18 for exchanging signals.

The CPU 11 controls various parts indicated above and executes various arithmetic processes according to a program. The ROM 12 stores various programs and data. The RAM 13 stores programs and data temporarily as a working area. The hard disk 14 stores various programs including an operating system and data.

An application program for generating document files and a printer driver for converting the document files into PDL data described in a Page Description Language (“PDL”) understood by the printing system 4 are installed on the hard disk 14. The printer driver is capable of providing instructions for printing document files prepared with the use of applications, setting up printing output conditions, and setting up tab sheet related matters. The printer drive contains programs for executing these settings.

The display 15 can be LCD, CRT, and other displays, on which various kinds of information are displayed. The input device 16 includes a pointing device such as a mouse, a keyboard, and others, and is used for executing various kinds of information inputs.

The network interface 17 is an interface for communicating with other devices on the network via the network 5 using standards such as Ethernet®, Token Ring, FDDI, etc.

The PC 1 constituted as such prepares PDL data in accordance with the printing setting contents received from the user via the printer driver to be described later, and transmits the PDL data to the printing system 4. Thus, the PC1 operates as an image forming controller to control image forming by the printer 3 as an image forming apparatus.

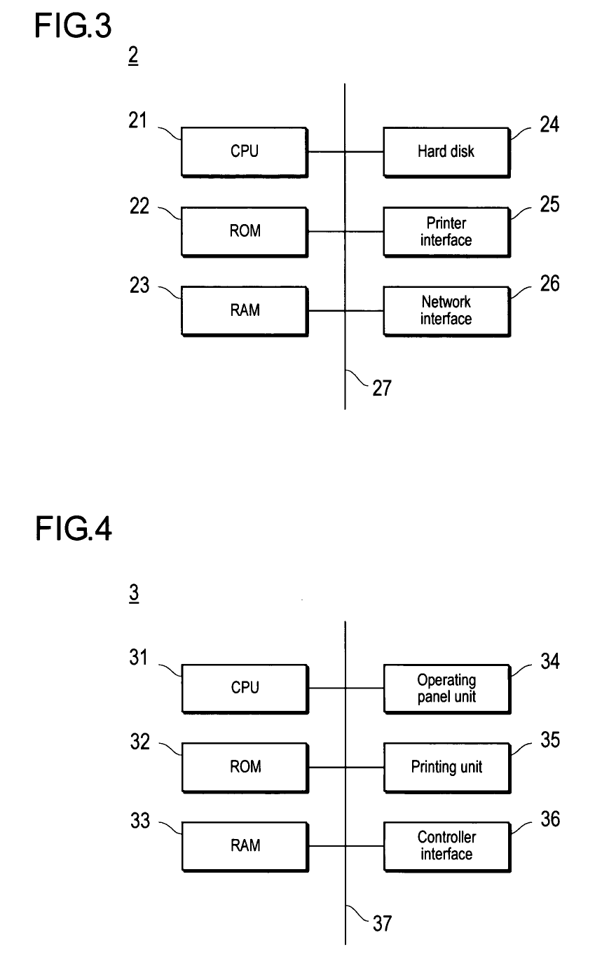

FIG. 3 is a block diagram showing the constitution of the printer controller 2 of the printer system 4 shown in FIG. 1.

The printer controller 2 is provided with a CPU 21, a ROM 22, a RAM 23, a hard disk 24, a printer interface 25, and a network interface 26, all of which are interconnected with each other via a bus 27 for exchanging signals. The descriptions of those parts of the printer controller 2 that have the same functions as those of the corresponding parts of the PC 1 will be omitted here to avoid being duplicative.

The ROM 22 and hard disk 24 stores a rasterizing process program for translating PDL data received from PC1 and developing it into bitmap data, which is bitmap type image data, as well as an image data process program for analyzing the received PDL data. The received PDL data and the bitmap data can be saved on the hard disk 24.

The printer interface 25 is an interface for communicating with the locally connected printer 3.

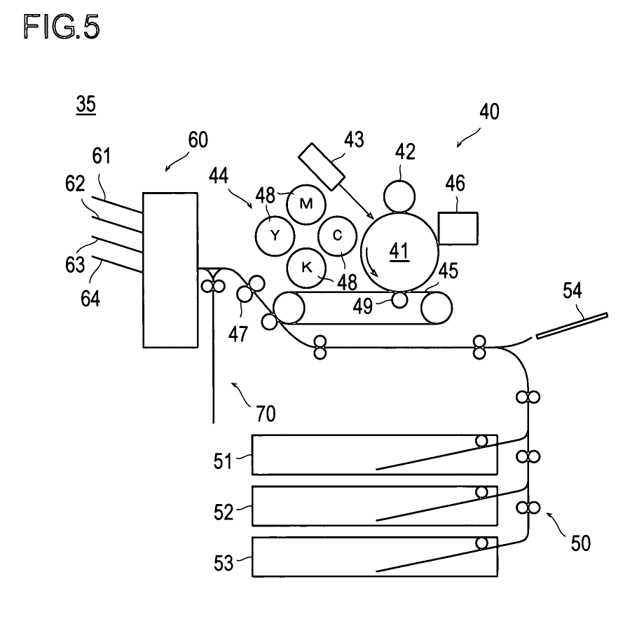

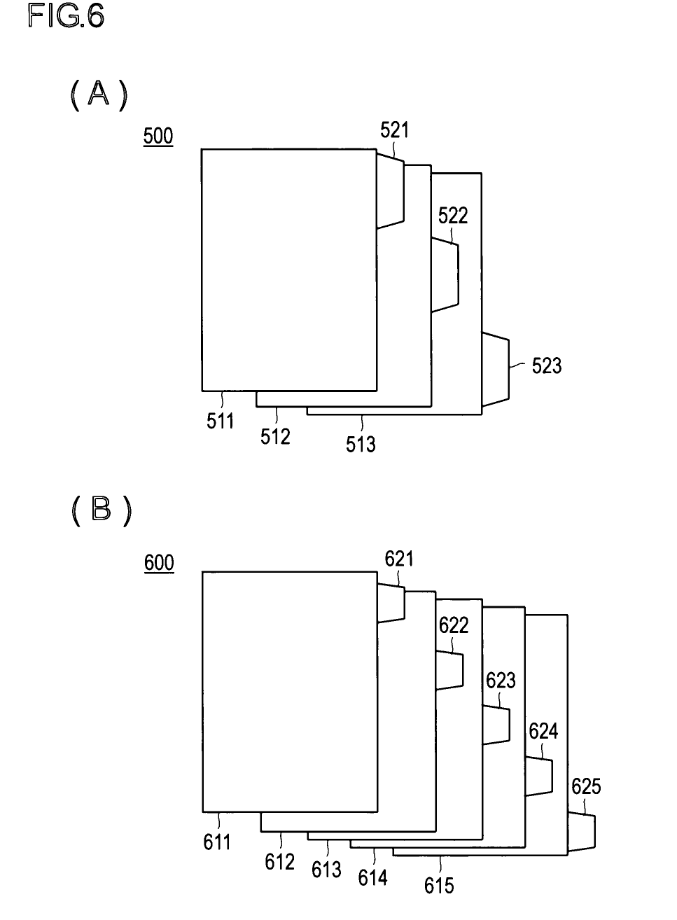

FIG. 4 is a block diagram showing the constitution of the printer 3 of the printing system 4 shown in FIG. 1. The printer 3 has a CPU 31, a ROM 32, a RAM 33, an operating panel unit 34, a printing unit 35, and a controller interface 36, all of which are interconnected with each other via a bus 37 for exchanging signals. The descriptions of those parts of the printer 3 that have the same functions as those of the corresponding parts of the PC 1 will be omitted here to avoid being duplicative.

The ROM 32 stores a printing process program to be executed based on printing data containing bitmap data received from the printer controller 2.

The operating panel unit 34 is equipped with a touch panel, a ten-key pad, a start button, a stop button and others to be used for displaying various data and entering various instructions.

The printing unit 35 prints images based on bitmap data received from the printer controller 2 using a publicly known image process such as the electronic photography process on recording media such as paper. The controller interface 36 is an interface for communicating with the locally connected printer controller 2.

FIG. 5 is a diagram showing the typical constitution of a printing unit 35.

The printing unit 35 has a paper supply unit 50 for supplying recording media such as printing paper and insertion sheets such as tab sheets, an image forming unit 40 for forming images on the recording media, and a paper discharge unit 60 for discharging printing paper and tab sheets. The printing unit 35 also has a reversing mechanism unit 70 for reversing the front and back sides of printing paper.

The image forming unit 40 of the printing unit 35 has a sensitizer drum 41 that rotates in the arrow direction, a charging device 42, exposing device 43, a developing device 44, an intermediate transfer belt 45, a cleaning device 46, and a fixing device 47. After the surface of the sensitizer drum 41 is evenly charged by means of the charging device 42, an electrostatic latent image is formed on the surface of the sensitizer drum 41 as it is irradiated with laser beams by the exposing device 43. The electrostatic latent image becomes an apparent image as the toner adheres to the electrostatic latent image on the sensitizer drum 41 in accordance with the turn of the sensitizer drum 41. The developing device 44 has a developing roller 48 for each of the colors, cyan (C), magenta (M), yellow (Y), and black (K) respectively, and developed toner images of these colors are transported to the transfer unit 49, then onto the intermediate transfer belt 45, and overlaid on top of each other there, so that the overlaid color image can be transferred to the printing paper supplied from the paper supply unit 50. The toner images are then fixed on the printing paper by the fixing device 47 and transported to the paper discharge unit 60.

The paper supply unit 50 has a plurality of sheet supply trays 51-54. The sheet supply tray 54 is a manual feed sheet supply tray. The paper discharge unit 60 is equipped with a plurality of paper discharge trays 61-64. The paper discharge unit 60 may have a post-processing part for providing post-processes such as punching or stapling to the printing paper transported there.

FIG. 6 shows an example of the tab sheet used in this embodiment, wherein (A) showing a three-tab tab sheet 500 and (B) showing a five-tab tab sheet 600. The tab sheets are also called index sheets. As shown in FIG. 6 (A), the tab sheet 500 is a set consisting of three sheets 511-513 and is called a “three-tab.” Each of the tab sheets 511-513 has a flat rectangular main body and a tab 521-531 respectively protruding at a designated position on a side of said main body. As shown in FIG. 6 (B), the tab sheet 600 is a set consisting of five sheets 611-615 and is called a “five-tab.” Each of the tab sheets 611-615 has a flat rectangular main body and a tab 621-625 respectively protruding at a designated position on a side of said main body.

The order of the tab sheets shown in FIG. 6 is called the normal order and is arranged in such a way that the tab of an upper layer sheet is found above the tab of a lower layer sheet in FIG. 6 when all of their tabs are on the right side. In case of the three-tab tab sheet 500, the tabs 521-523 are provided on one side of the main body lowering their positions sequentially in three steps from the top to the bottom. The positions of the tabs 521, 522, and 523 are identified as ⅓, ⅔, and 3/3 respectively. In case of the five-tab tab sheet 600, the tabs 621-625 are provided on one side of the main body lowering their positions sequentially in five steps from the top to the bottom. The positions of the tabs 621, 622, 623, 624, and 625 are identified as ⅕ (one-fifth), ⅖ (two-fifths), ⅗ (three-fifths), ⅘ (four-fifths), and 5/5 (five-fifths) respectively. The tab sheets 500 and 600 are normally provided in multiple sets in the sheet supply tray.

The operation of the network system in this embodiment will be described in the following.

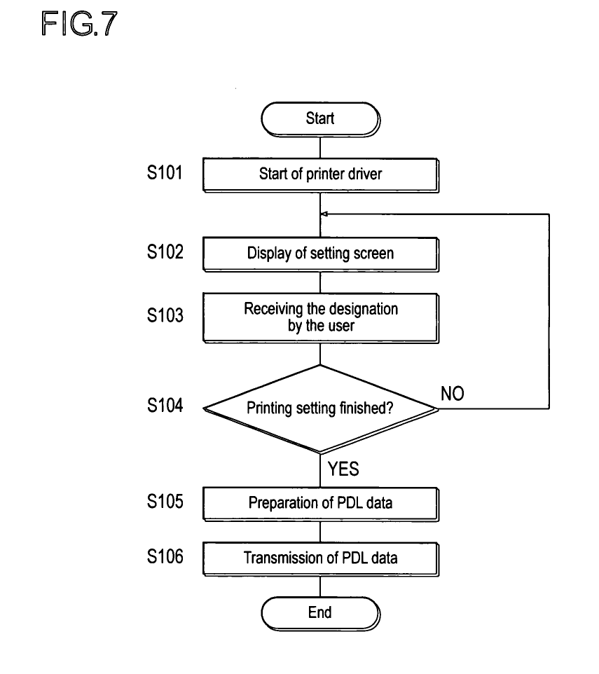

FIG. 7 is a flow chart showing the process procedure on the PC 1. The algorithm shown in the flowchart of FIG. 7 is stored as a program in a memory unit such as a hard disk 14 of the PC 1 and executed by the CPU 11.

As a preamble, a document file to be printed is prepared by the PC 1. The document file is prepared by an application installed on the PC 1.

When the printing process for a document file is executed, the printer driver is activated via printing setting dialogs of the application based on the user's operation (S101).

Next, when a selection tab 101 is clicked on the printing setting screen which is displayed by the printer driver, the setting start request concerning the chapter break printing function and the tab sheet insertion function is received, and the setting screen will be displayed on the display 15 (S102). The chapter break printing function means a function for printing the leading page for each break of the text contained in the document file during double-side printing, and typical breaks are “chapter” and/or “section” breaks.

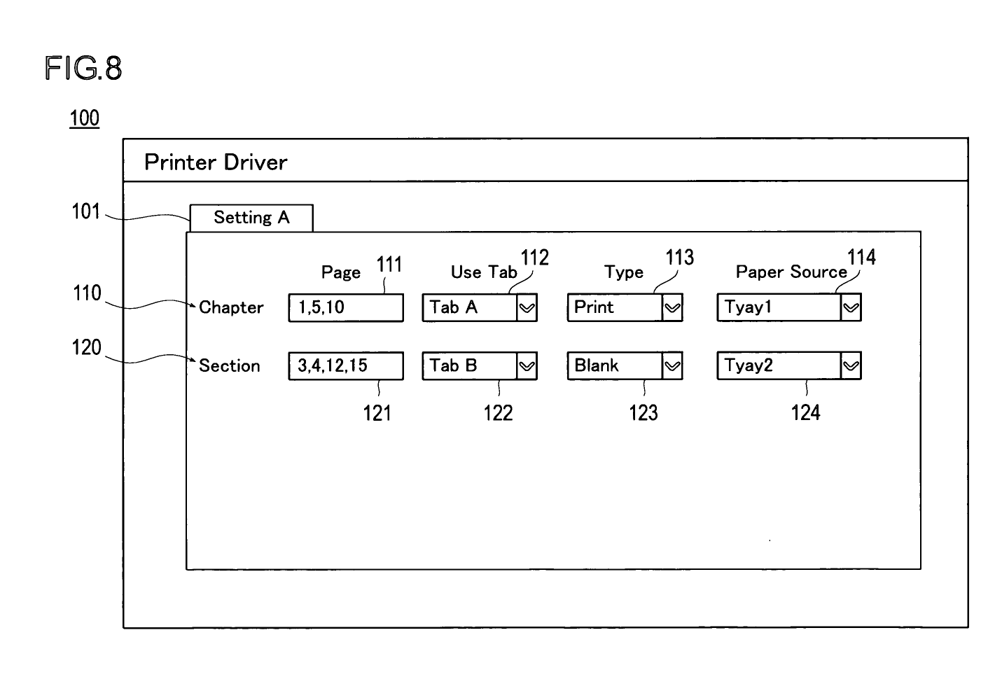

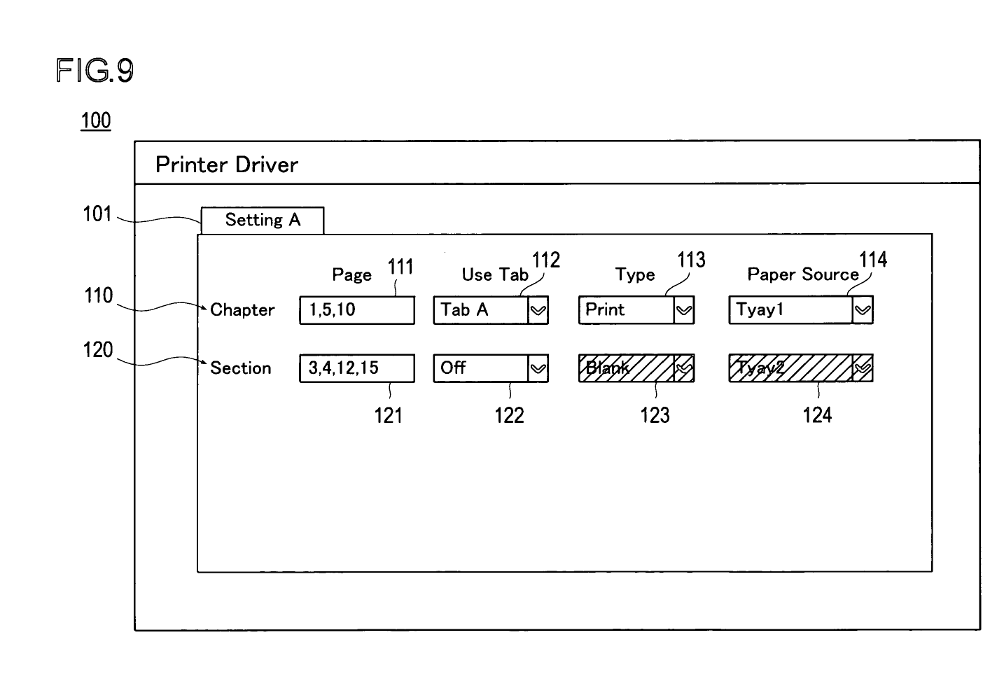

FIG. 8 is a diagram showing an example of the setting screen 100.

The setting screen 100 has a chapter setting part 110 for a setting concerning “chapter” which is a first kind of break in a document, and a section setting part 120 for a setting concerning “section” which is a second kind of break, i.e., a finer break, in a document.

The chapter setting part 110 includes a first chapter break printing function setting part 111 that allows the user to set up the leading page of a “chapter” in a document for setting up the first chapter break printing function in order to print the leading page of the “chapter” in the document during double-side printing, while the chapter setting part 120 includes a second chapter break printing function setting part 121 that allows the user to set up the leading page of a “section” in a document for setting up the second chapter break printing function in order to print the leading page of the “section” in the document during double-side printing. In other words, with the first chapter break printing function setting part 111 and the second chapter break printing function part 121, the user can designate a page to be printed on the surface of the recording medium during double-side printing a document consisting of a plurality of pages.

Moreover, the chapter setting part 110 includes a first insertion setting part 112 that allows the user to designate insertion of a tab sheet to the page designated in the first chapter break printing function setting part 111, and the section setting part 120 includes a second insertion setting part 121 that allows the user to designate insertion of a tab sheet to the page designated in the second chapter break printing function setting part. In other words, in the first insertion setting part 112 and the second insertion setting part 122, the positions where tab sheets are to be inserted are the page positions designated by the first chapter break printing function setting part 111 and the second chapter break printing function setting part 121, so that the user need not to designate the tab insertion positions again. Here the term “page” signifies a page of a document which is the object of the printing process and is a notion that does not include the tab paper. In this embodiment, a tab sheet is inserted immediately preceding the designated page.

The first insertion setting part 112 and the second insertion setting part 122 each displays a plurality of options for selecting the type of tab sheet. The type of tab sheet is not limited to the three-tab and five-tab sheets shown in FIG. 6, rather it can include tab sheets consisting of other numbers of tabs such as three; seven and 10 tabs, or tab sheets of different colors. Further, in addition to a tab sheet, or in place of a tab sheet, a regular sheet of paper (including color paper), thick paper, thin paper or any other kinds of paper can be used as an insertion sheet to be inserted in a printed matter.

In other words, it is possible to designate different kinds of insertion paper for the first insertion setting part 112 and the second insertion setting part 122. FIG. 8 shows a case where different kinds of tab sheets are designated to be inserted (“Tab A” and “Tab B”), where “Tab A” being a 3-tab sheet and “Tab B” being a 5-tab sheet. When it is quoted as “different kinds” of insertion sheets here, it is meant to include a case of different kinds of tab sheets, e.g., 3-tab and 5-tab, but also different kinds of paper, e.g., tab sheet and thin paper.

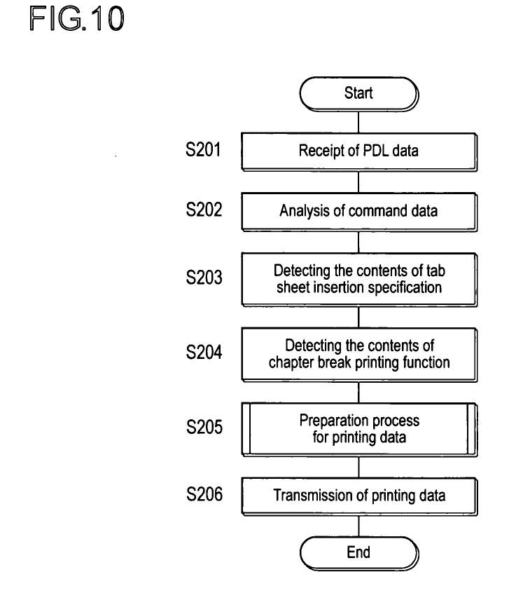

Moreover, by designating “Off” (refer to FIG. 9) either in the first insertion setting part 112 or the second insertion setting part 122, it is possible to designate no tab sheet insertion. In such a case, only the chapter break printing function will be designated.

The chapter setting part 110 includes the first tab printing setting part 113 for designating whether or not to print on the of a tab sheet to be inserted at a “chapter” break (hereinafter called “chapter tab sheet”), and the chapter setting part 120 includes a second tab printing setting part 123 for designating whether or not to print on the tab of a tab sheet to be inserted at a “section” break (hereinafter called “section tab sheet”). The available options here are “Print” and “Blank,” where selecting “Print” causes the tab to be printed and selecting “Blank” causes the tab not to be printed. The information to be printed on the tab of a tab sheet is separately designated in a tab printing information setting part (not shown).

The chapter setting part 110 includes a first sheet supply tray setting part 114 that the user can use for selecting a chapter tab sheet supply tray, and the section setting part 120 includes a second sheet supply tray setting part 124 that the user can use for selecting a section tab sheet supply tray. The first sheet supply tray setting part 114 and the second sheet supply tray setting part 124 each displays a plurality of options for selecting sheet supply trays. Here “Tray 1” designates a sheet supply tray 51 and “Tray 2” designates a sheet supply tray 52 (see FIG. 5).

Going back to the flowchart of FIG. 7, the user's designation is received in step S103. Specifically, the designation for the chapter break printing function is received first. In other word, the user inputs the leading page of a “chapter” in a document to the first chapter break printing function setting part 111, and also enters the first page of a “section” in the document to the second chapter break printing function setting part 121. The designation for the tab sheet insertion is also received. In other words, the user designates the type of the chapter tab sheet at the first insertion setting part 112 and the type of the section tab sheet at the second insertion setting part 122. The user can designate “Off” here as well. Moreover, as mentioned above, the page positions designated in the first chapter break printing function setting part 111 and the second chapter break printing function setting part 121 are received as the position to which the tab sheet is to be inserted.

Also, the designation for the tab sheet printing is received as well. The user designates whether to print the tab of the chapter tab sheet or not at the first tab printing setting part 113, and whether to print the tab of the section tab sheet or not at the second tab printing setting part 123. Also, the sheet supply tray for supplying tab sheets is designated as well. The user designates a first sheet supply tray for the chapter break tab sheet at the first sheet supply tray setting part 114 and designates a second sheet tray for the section break tab sheet at the second sheet tray setting part 124. For example, if “Off” is designated in the second insertion setting part 122 as shown in FIG. 9, the second tab printing setting part 123 and the second sheet supply tray setting part 124 are grayed out (shown as hatching in FIG. 9), suggesting that no designation can be received.

Furthermore, other designations by the user, such as the designation for double-side printing, can be received at other printing setting screens, other than the setting screen 100.

In step S104, a judgment is made as to whether the printing setting work is finished or not. For example, when the display is switched to another printing setting screen, different from the setting screen 100, and the instruction button for printing start (not shown) is clicked, it is judged that the printing setting work is finished. If the printing setting work is not finished (S104: No), the program returns to step S102.

If the printing setting work is completed (S104: Yes), PDL data is generated as the document file prepared by using the application is converted (S105).

The setting information obtained in said step S103 is described in the PDL data as command data.

For example, the command data (PJL) such as follows are described:

PERPAGESET=TRAY1 . . . , Chapter, . . . 3TAB, 1, 5, 10

PERPAGESET=TRAY2 . . . , Section, . . . 5TAB, 3, 4, 12, 15

The command data indicates that the supply source of the chapter tab sheet is “Tray1” (sheet supply tray 51 shown in FIG. 5) and the leading pages of the “chapters” are page 1, 5, and 10, while the supply source of the section tab sheet is “Tray2” (sheet supply tray 52 shown in FIG. 5) and the leading pages of the “sections” are page 3, 4, 12, and 15.

For another example, the command data (PJL) such as follows are described:

PERPAGESET=TRAY1 . . . ,Chapter, . . . 3TAB,1,5,10

PERPAGESET= . . . Section, . . . ,3,4,12,15

The command indicates that the supply source of the chapter tab sheet is “Tray1” (sheet supply tray 51 shown in FIG. 5), the chapter tab sheet type is 3-tab, and the leading pages of the “chapters” are page 1, 5, and 10, while there is no insertion designation for the section tab sheet and the leading pages of the “sections” are page 3, 4, 12, and 15. Other setting information is also described as command data in the PDL data.

Next, in step S106, the PDL data thus prepared is transmitted to the printer controller 2 of the printing system 4 via the network 5.

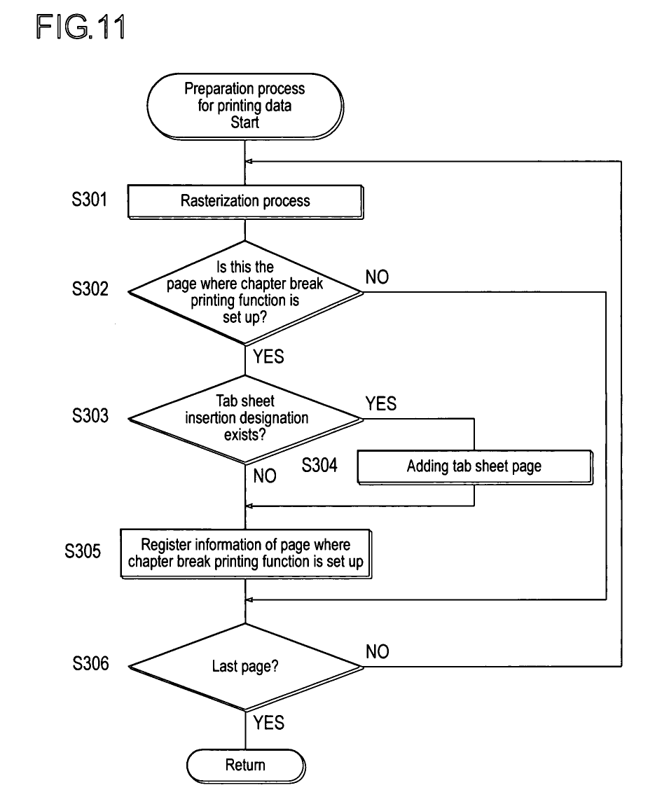

Next, the image recording process in the printer controller 2 will be described below referring to FIG. 10 and FIG. 11. The algorithm shown in the flowchart of FIG. 10 and FIG. 11 is stored as a program in a memory unit such as a hard disk 24 of the printer controller 2 and executed by the CPU 21.

First, the printer controller 2 receives the PDL data from the PC1 (step S201), and analyzes the command data described in the PDL data (S202).

Next, the contents of the tab sheet insertion designation (including the presence or lack of it) is detected based on the command data analysis result (S203) to detect the contents of the chapter break printing function setting (including the presence or lack of it) (S204).

Next, based on the PDL data received, the preparation process is executed for the printing data by adding the header information including various kinds of setting information to the bitmap data for printing on the printer 3 (S205). The detail such printing data preparation process will be described later.

Next, the prepared printing data is transmitted as a printing job to the printer 3 (S206).

In the printing data preparation process, as shown in FIG. 11, a rasterization process is applied first to the first page of the received PDL data to obtain bitmap data which is the bitmap type image data (301).

Next, a judgment is made whether or not the object page of the process is a page where the chapter break printing function is set up, i.e., whether or not it is a leading page of a “chapter” or a “section” (S302).

If the object page of the process is not a page where the chapter break printing function is set up (S302: No), the program proceeds to the step S306.

On the other hand, if the object page of the process is a page where the chapter break printing function is set up (S302: Yes), a judgment is made whether or not the tab sheet insertion is designated to the object page of the process (S303).

If the tab sheet insertion is not designated to the object page of the process (S303: No), the program advances to step S305.

On the other hand, if the tab sheet insertion is designated to the object page of the process (S303: Yes), the program advances to step S305 after adding the tab sheet page. The tab sheet page is added separately from the page of the document for normal printing.

In step S305, the information about the page, for which the chapter break printing function is set up, is registered. In other words, the information about the page, for which the chapter break printing function is set up, is added to the printing data as a part of the setting information.

In step S306, a judgment is made whether or not the object page of the process is the final page. If the object page of the process is not the final page (S306: No), the program returns to step S301. On the other hand, if the object page of the process is the final page (S306: Yes), the program returns to the flowchart of FIG. 10.

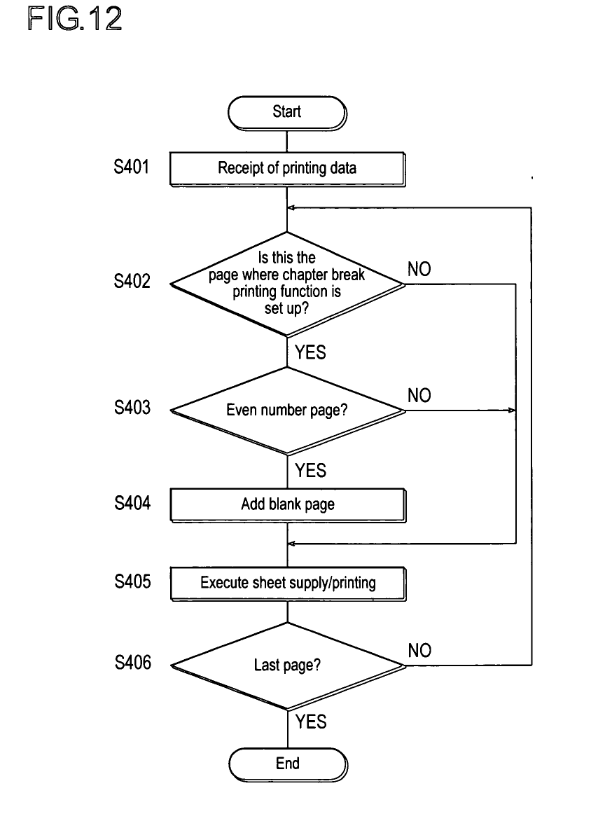

Next, the job process in the printer 3 will be described below referring to FIG. 12. The algorithm shown in the flowcharts of FIG. 12 is stored as a program in a memory unit such as a ROM 32 of the printer 3 and executed by the CPU 31.

The following is a description about a case when the double-side printing and the printing function are set up for the printing data.

First, the printer 3 receives the printing data from the printer controller 2 as the printing job (step S401).

Next, a judgment is made whether or not the first page of the received printing data is a page where the chapter break printing function is set up, i.e., whether or not it is a leading page of a “chapter” or a “section” (S402). If the object page of the process is not a page where the chapter break printing function is set up (S402: No), the program proceeds to the step S405.

On the other hand, if the object page of the process is a page where the chapter break printing function is set up (S402: Yes), a judgment is made whether or not the object page of the process is an even numbered page (S403). If the object page of the process is not an even numbered page (S403: No), the program advances to step S405.

On the other hand, if the object page of the process is an even numbered page (S403: Yes), the program advances to step S405 after adding a blank page (S404). The blank page is a page without any image data to be printed, and it is added immediately preceding the object page of the process. Consequently, the object page of the process, in other words, the leading page of a “chapter” or “section,” becomes an odd-numbered page and ends up being printed on the front of the sheet.

In step S405, sheet supply and/or printing will be executed as designated with respect to the object page of the process. If the object page of the process happens to be a tab sheet page, a tab sheet will be supplied from the designated sheet supply tray.

In step S406, a judgment is made whether or not the object page of the process is the final page. If the object page of the process is not the final page (S406: No), the program returns to step S402. On the other hand, if it has reached the final page (S406: Yes), the process is terminated.

As can be seen from the above, the present embodiment provides to the user the chapter break printing function setting parts 111 and 121 that allow the user to specify the leading page at a break of a document in order to set up the chapter break printing function for printing the leading page at the break of a “chapter,” “section,” and the like of the document during double-side printing, as well as the insertion setting parts 112 and 122 that allow the user to specify the tab sheet insertion at the page designated by the chapter break printing function setting parts 111 and 121.

Consequently, the user will be able to specify the leading page at the break of “chapter,” “section,” and the like of a document linked with the insertion of a tab sheet at the particular page when needed. Thus, the user will be able to set up both the chapter break printing function and the tab sheet insertion during double-side printing with a high productivity and without fail.

Moreover, as another aspect of this invention, it provides to a user, in printing a document consisting of a plurality of pages on both sides of a printing medium, a first setting part that allows the user to specify a page to be printed on the front surface of said printing medium and a second setting part that allows the user to set up insertion of an insertion sheet to said page which is designated by said first setting part. Consequently, the user will be able to specify the page to be printed on the front side of the printing medium linked with the designation of the insertion of a tab sheet at the particular page when needed. As a result, it is not necessary for the user to specify the page twice so that the user can perform the page designation with a higher productivity and without fail.

The invention is not limited to the embodiment described above, but also can be changed in various ways within the scope of the claims.

For example, although we used “chapter” and “section” in the above embodiment as examples of breakpoints in a document in the above embodiments, the present invention is not limited to them. The breakpoints of a document can only be a single “chapter” or can include “volume,” “chapter,” and “section,” i.e., three or more.

Moreover, although it is described in the above embodiment a case of setting up the chapter break printing function and the tab sheet insertion function by the printer driver, it can also be set up by an application instead of the printer driver.

Further, although it is described in the above embodiment a case of setting up the chapter break printing function and the tab sheet insertion function using the setting screen 100, which is displayed on the display 15 of the PC 1, it can also be set up using the tab sheet setting screen, which is displayed on the operating panel unit 34 of the printer 3.

Furthermore, although it is describe in the above embodiment a constitution wherein the printing system 4 is divided into the printer controller 2 and the printer 3, both of which are locally connected, the printer controller 2 can be built into the printer 3.

Also, although the embodiments described above uses a printer as the image forming apparatus, the invention is not limited to it. The present invention is applicable to an image forming apparatus such as MFP (Multi-Function Peripheral) and a copying machine as well.

The means and method of conducting various processes in the network system according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable storage medium is normally transferred to and stored in a memory unit such as a hard disk. Said program can also be provided as independent application software or can be built into the software of the image processing device as a part of its function.

What is claimed is:

1. A computer readable recording medium stored with a control program for controlling an image forming apparatus, said control program causing a computer to execute a process comprising:
1) providing to a user with a chapter break printing function setting part and an insertion setting part, the chapter break printing function setting part allowing the user to designate a leading page of a break in a document in order to set up a chapter break printing function for printing the leading page on the front surface at the break of the document while double-side printing, the insertion setting part allowing the user to designate an insertion of an insertion sheet to a page designated at said chapter break printing function setting part; and
2) receiving the designation of the page at said printing function setting part and the designation of the insertion of the insertion sheet at said insertion setting part.

2. The computer readable recording medium as claimed in claim 1, wherein
said insertion sheet is a tab sheet.

3. The computer readable recording medium as claimed in claim 1, wherein
said insertion sheet is the one the user selects from a plurality of types of insertion sheets.

4. The computer readable recording medium as claimed in claim 1, wherein
said chapter break printing function setting part has a first chapter break printing function setting part that allows the user to designate a leading page of a first break of said document in order to set up a first chapter break printing function for printing the leading page of a first break in a given document on the front side during double-side printing, and a second chapter break printing function setting part that allows the user to designate a leading page of a second break, which is finer than the first break, of said document in order to set up a second chapter break printing function for printing the leading page of a second break in the document on the front side during double-side printing;
said insertion setting part having a first insertion setting part that allows the user to designate insertion of an insertion sheet to the page designated at said first chapter break printing function setting part and a second insertion setting part that allows the user to designate insertion of an insertion sheet to the page designated at said second chapter break printing function setting part.

5. The computer readable recording medium as claimed in claim 4, wherein
said first level of classification is a chapter, and said second level of classification is a paragraph.

6. A computer readable recording medium stored with a control program for controlling an image forming apparatus, said control program causing a computer to execute a process comprising:
1) in printing a document consisting of a plurality of pages on both sides of a printing medium, providing a user with a first setting part and a second setting part, the first setting part allowing the user to designate a page to be printed on the front surface of said printing medium, and the second setting part allowing the user to set up insertion of an insertion sheet to said page which is designated by said first setting part; and
2) receiving the designation of the page at said first setting part and the setting of the insertion of the insertion sheet at said second setting part.

7. The computer readable recording medium as claimed in claim 6, wherein
said insertion sheet is a tab sheet.

8. The computer readable recording medium as claimed in claim 6, wherein
said insertion sheet is the one the user selects from a plurality of types of insertion sheets.

9. The computer readable recording medium as claimed in claim 6, wherein
said first setting part has a first chapter break printing function setting part that allows the user to designate a leading page of a first break of said document in order to set up a first chapter break printing function for printing the leading page of a first break in a given document on the front side during double-side printing, and a second chapter break printing function setting part that allows the user to designate a leading page of a second break, which is finer than the first break, of said document in order to set up a second chapter break printing function for printing the leading page of a second break in the document on the front side during double-side printing;
said second setting part having a first insertion setting part that allows the user to designate insertion of an insertion sheet to the page designated at said first chapter break printing function setting part and a second insertion setting part that allows the user to designate insertion of an insertion sheet to the page designated at said second chapter break printing function setting part.

10. The computer readable recording medium as claimed in claim 9, wherein
said first break is a chapter, and said second break is a paragraph.

11. A controlling method for controlling an image forming apparatus comprising:
1) providing a user with a chapter break printing function setting part and an insertion setting part, the chapter break printing function setting part allowing the user to designate a leading page of a break in a document in order to set up a chapter break printing function for printing the leading page on the front surface at the break of the document while double-side printing, the insertion setting part allowing the user to designate an insertion of an insertion sheet to a page designated at said chapter break printing function setting part; and
2) receiving the designation of the page at said printing function setting part and the designation of the insertion of the insertion sheet at said insertion setting part.

12. A controlling method for controlling an image forming apparatus comprising:
1) in printing a document consisting of a plurality of pages on both sides of a printing medium, providing a user with a first setting part and a second setting part, the first setting part allowing the user to designate a page to be printed on the front surface of said printing medium, and the second setting part allowing the user to set up insertion of an insertion sheet to said page which is designated by said first setting part; and
2) receiving the designation of the page at said first setting part and the setting of the insertion of the insertion sheet at said second setting part.

13. An image forming apparatus, comprising:
a chapter break printing function setting part that allows a user to designate a leading page at a break in a document in order to set up a chapter break printing function for printing the leading page on the front surface at the break of the document while double-side printing; and
an insertion setting part that allows the user to designate an insertion of an insertion sheet to a page designated at said chapter break printing function setting part.

14. An image forming apparatus, comprising:
in printing a document consisting of a plurality of pages on both sides of a printing medium, a first setting part that allows a user to designate a page to be printed on the front surface of said printing medium; and
a second setting part that allows the user to set up insertion of an insertion sheet to said page which is designated by said first setting part.
